(19) United States
(12) Patent Application Publication
(10) Pub. No.: US 2003/0138202 A1
(43) Pub. Date: Jul. 24, 2003

(54) Optical collimator

(76) Inventors: Mingbao Zhou, Shenzhen (CN); River Yang, Shenzhen (CN); Qing Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/269,128

(22) Filed: Oct. 10, 2002

(30) Foreign Application Priority Data
Jan. 18, 2002 (TW) 91200443

(51) Int. Cl. G02B 6/32

(52) U.S. Cl. 385/33; 385/79

(57) ABSTRACT

An optical collimator (10) for collimating light beams coming from an optical fiber (13) includes the at least one optical fiber, a ferrule (12), a molded lens (11), a mounting tube (14) and a metal holder (15). The optical fiber has an exposed end and the ferrule defines a through hole for receiving and fixing the optical fiber therein. A forward face (122) of the ferrule is ground at an oblique angle and is flush with the exposed end of the optical fiber. The molded lens is cylindrical in shape and has an oblique surface coinciding with that of the ferrule and the exposed end of the optical fiber. The molded lens has a convex surface at its forward face (111).

### BACKGROUND OF THE INVENTION

1. Field of the Invention

The present invention is related to optical collimators, and more particularly to optical collimators which employ a molded lens to collimate light beams coming from an exposed end of an optical fiber to parallel light beams, or to focus parallel light beams entering a forward face of the optical collimator to a point coincident with the end of the optical fiber.

2. Description of the Prior Art

A Graded Index (GRIN) lens is a popular optical collimating element, which is utilized in optical devices such as optical switches or optical couplers. The light collimated by the optical collimating element may be efficiently and controllably utilized for transmission or testing.

As shown in FIG. 6, a conventional optical collimator 100 comprises an optical fiber 110, a ceramic ferrule 120, a GRIN lens 130 and an outer glass tube 140. The ferrule 120 has an inner end 122, an outer end 124, and a through hole 126 defined between the inner and outer ends 122, 124. The optical fiber 110 is typically sealed in the through hole 126 with UV-cured epoxy. The GRIN lens 130 has an inner end 132 and an outer end 134. The inner end 132 of the GRIN lens 130 is adjacent the inner end 122 of the ferrule 120, and is obliquely ground and polished to be parallel to the inner end 122. The longitudinal axis of the GRIN lens 130 is aligned with the longitudinal axis of the optical fiber 110. The ferrule 120 and the GRIN lens 130 are positioned and aligned in the glass tube 140, so that output light from the GRIN lens 130 can be accurately focused on the inner end 112 of the optical fiber 110.

The conventional optical collimator 100 has some disadvantages. Firstly, the GRIN lens 130 is commonly made using the ion-exchange method, which requires a long manufacturing time and further steps of polishing after initial formation, so it is hard to make and is expensive. Secondly, some of the chemicals used in the ion-exchange method can contaminate the environment and endanger the fabrication workers.

An improved optical collimator is needed to overcome the above-described disadvantages of conventional optical collimators.

### SUMMARY OF THE INVENTION

Accordingly, an object of the present invention is to provide an optical collimator which uses a molded lens, the production of which is relatively environmentally friendly.

Another object of the present invention is to provide an optical collimator having a high precision lens.

A further object of the present invention is to provide an optical collimator whose production is time saving and relatively inexpensive.

To solve the problems of the prior art and to achieve the objects set forth above, an optical collimator of the present invention comprises an optical fiber, a ferrule, a molded lens, a mounting tube and a metal holder. The optical fiber has an exposed end and the ferrule defines a through hole for receiving and fixing the optical fiber therein. The ferrule has a rearward face and a forward face. The forward face of the ferrule is ground at an oblique angle and is flush with the exposed end of the optical fiber. The molded lens is cylindrical in shape and has an oblique surface coinciding with in slope that of the ferrule and the exposed end of the optical fiber. A forward face of the molded lens has a convex surface.

Since the present invention employs a molded lens as the collimating element, and the cost and environmental problem are reduced.

Other objects, advantages and novel features of the present invention will become apparent from the following detailed description of preferred embodiments thereof with reference to the attached drawings, in which:

### BRIEF DESCRIPTION OF THE DRAWINGS

FIG. 1 is a cross-sectional view of an optical collimator according to a first embodiment of the invention.

FIG. 2 is a cross-sectional view of a molded lens of the optical collimator of FIG. 1.

FIG. 3 is an essential optical paths diagram of the optical collimator of FIG. 1.

FIG. 4 is a cross-sectional view of an optical collimator according to a second embodiment.

FIG. 5 is an essential optical path diagram of the optical collimator of FIG. 4.

FIG. 6 is a schematic, cross-sectional view of an conventional optical collimator.

### DETAILED DESCRIPTION OF THE PREFERRED EMBODIMENT

For facilitating understanding, like components are designated by like reference numerals throughout the various embodiments of the invention as shown in the various drawing figures.

Reference will now be made to the drawing figures to describe the present invention in detail.

Referring to FIGS. 1-3, an optical collimator 10 in accordance with a preferred embodiment of the present invention comprises a molded lens 11, a ferrule 12, an optical fiber 13, a mounting tube 14 and a metal holder 15.

The ferrule 12 is cylindrical in shape and has a forward face 122, a rearward face (not labeled) and a through hole 121 defined between the forward face 122 and the rearward face (not labeled). A diameter of the through hole 121 is slightly greater than a diameter of the optical fiber 13. A conical opening (not labeled) coaxial with the through hole 121 is defined in the rearward face (not labeled). The optical fiber 13 has an exposed end and is preferably fixed in the through hole 121 with epoxy such as UV-cured epoxy or 353-ND epoxy. To improve optical performance, the forward face 122 of the ferrule 12 and an exposed end (not labeled) of the optical fiber 13 are ground and polished at an oblique angle relative to an imaginary plane constructed perpendicular to a longitudinal axes of the ferrule 12. The angle is preferably between 6 and 8 degrees.

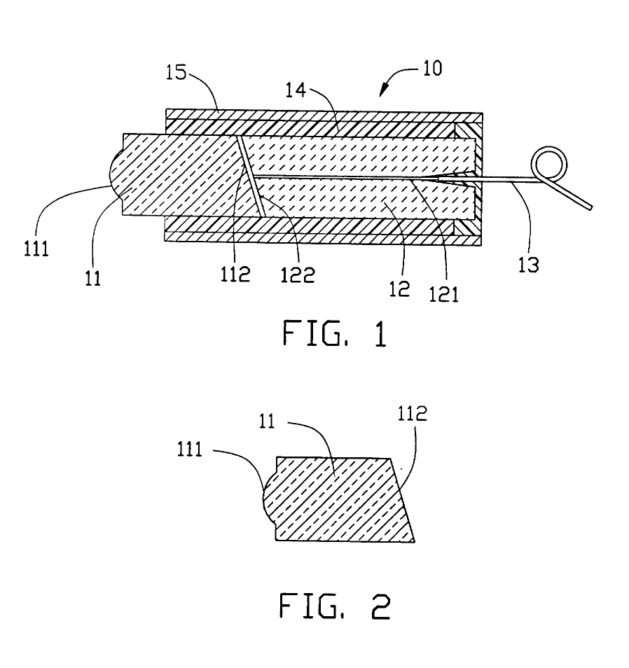

Referring to FIG. 2, the molded lens 11 is substantially cylindrical and has a uniform refractive index. A rearward face 112 of the molded lens 11 forms an oblique angle with an imaginary plane constructed perpendicular to a longitudinal axis of the molded lens 11. The angle is preferably between 6 and 8 degrees. A forward face 111 of the molded lens 11 has a convex surface. The rearward face 112 and the forward face 111 are both coated with an antireflective coating to reduce reflection losses.

The molded lens 11 may be made entirely using conventional methods such as injection molding. So the molded lens can be formed with a high quality surface and high surface accuracy, and requires no further preparatory operations, such as grinding or polishing. Time required to make the molded lens is short and the cost is low. Further, the antireflective coatings applied to the two end faces of the molded lens do not influence the optical path of transmitted light beams since the molded lens has a uniform refractive index. Finally, the fabrication process does not contaminate the environment or endanger the fabrication workers.

The mounting tube 14 is in the shape of a hollow cylinder and defines a receiving cavity (not labeled) for receiving the molded lens 11 and the ferrule 12 therein. The metal holder 15 covers on outer surface of mounting tube 14 to protect the optical collimator 10.

In assembly, the exposed end of the optical fiber 13 is coated with epoxy and is threaded through the conical opening and into the through hole 121 of the ferrule 12. The ferrule 12 with the attached optical fiber 13 then have a corresponding end grinded to a same oblique angled surface as the molded lens 11 has. The molded lens 11 and the ferrule 12 with the attached optical fiber 13 are arranged in the receiving cavity of the mounting tube 14 so that the forward face 122 of the ferrule 11 is parallel to and separated from the rearward face 112 of the molded lens 11 by a narrow gap defined between the molded lens 11 and the ferrule 12. This arrangement is designed to assure precise collimation of light beams coming from the optical fiber 13. The metal holder 15 is attached to the mounting tube 14 with epoxy.

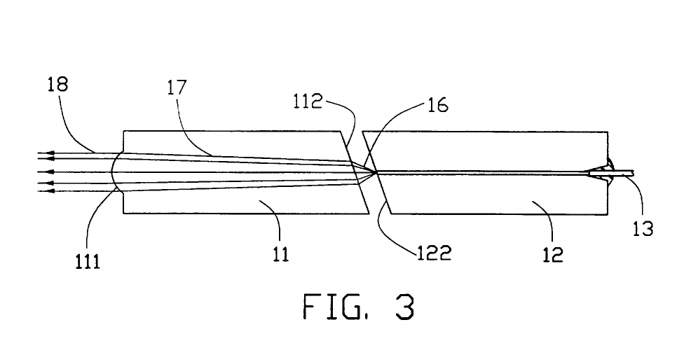

As shown in FIG. 3 in the present invention, a focal point of the molded lens 11 is located at the point where the through hole 121 intersects with the forward face 122 of the ferrule 12. Scattered light beams 16 emitted from the optical fiber 13 are refracted at the rearward face 112 of the molded lens 11, then the light beams 17 are refracted again at the forward face 111 of the molded lens 11 to emerge as parallel light beams 18 from the molded lens 11. The collimating process is accomplished.

Since optical paths are reversible in lenses, light beams from a mating optical element directed at a front end of the optical collimator can be focused to the exposed end of the optical fiber 13 by the molded lens 11.

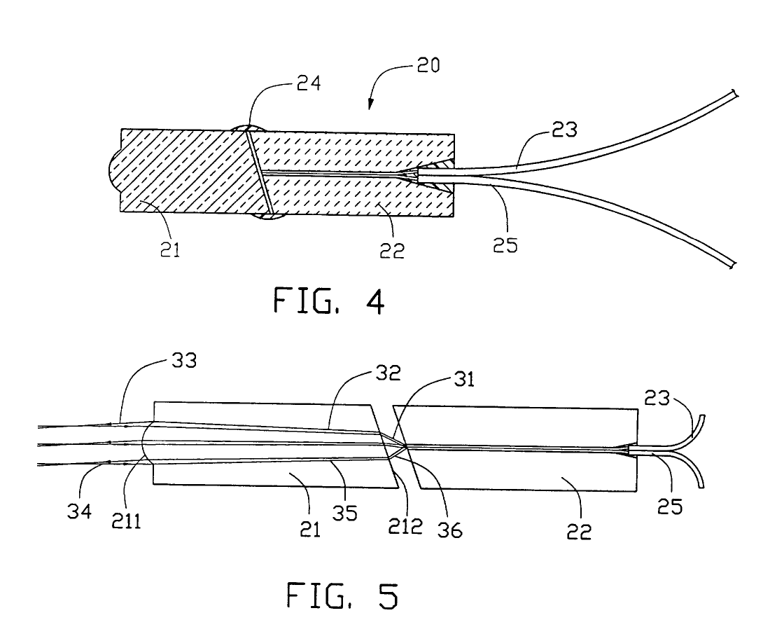

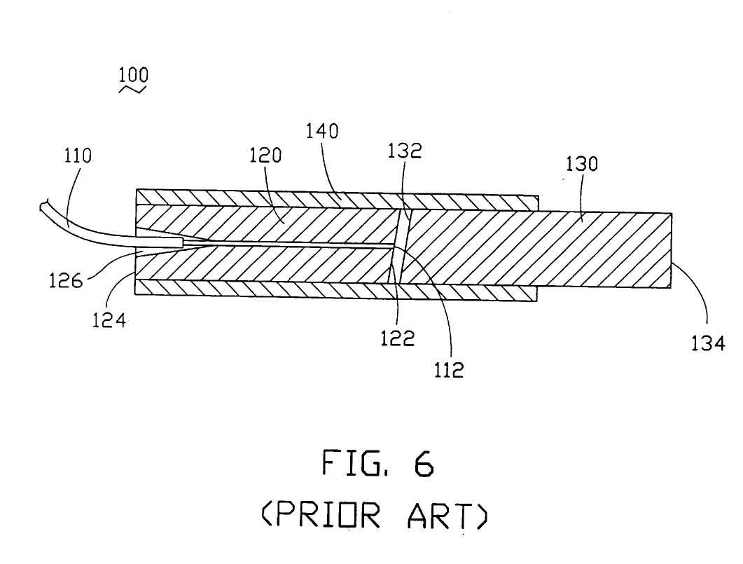

Referring also to FIGS. 4 and 5, a second embodiment is shown. An optical collimator 20 comprises a molded lens 21, a ferrule 22, a first optical fiber 23 and a second optical fiber 25.

The molded lens 21, the ferrule 22 and the first and second optical fibers 23, 25 are each similar to the corresponding elements of the first embodiment. The difference between the first and second embodiments is in the construction of the ferrule 22, which has a through hole sized to receive the two optical fibers 23, 25. A connecting material 24 is attached between ends of the molded lens 21 and the ferrule 22 to hold them together.

Referring to FIG. 5, in the forward direction, scattered light beams 31 emitted from the first optical fiber 23 are refracted at a rearward face 212 of the molded lens 21, pass through the lens 21 as light beams 32, and are again refracted at a forward face 211 of the molded lens 21 to emerge as parallel light beams 33. In the reverse direction, parallel light beams 34 are refracted at the forward face 211, travel through the molded lens 21 as optical beams 35, are again refracted at the rearward face 212 to travel as light beams 36 to a focal point at the free end of the second optical fiber 25.

It is to be understood, however, that even though numerous characteristics and advantages of the present invention have been set forth in the foregoing description, together with details of the structure and function of the invention, the disclosure is illustrative only, and changes may be in detail, especially in matters of shape, size, and arrangement of parts within the principles of the invention to the full extent indicated by the broad general meaning of the terms in which the appended claims are expressed.

What is claimed is:

1. An optical collimator comprising:
an optical fiber for transmitting light beams;
a ferrule for fixing and holding the optical fiber;
a molded lens located adjacent the ferrule and the optical fiber for collimating the light beams coming from the optical fiber.

2. The optical collimator as described in claim 1, wherein the molded lens has a uniform refractive index and defines a rearward face.

3. The optical collimator as described in claim 2, wherein the ferrule has a forward face flush with the optical fiber.

4. The optical collimator as described in claim 3, wherein the rearward face of the molded lens is arranged adjacent the forward face of the ferrule.

5. The optical collimator as described in claim 4, wherein the forward face of the ferrule and the rearward face of the molded lens each form an oblique angle with an imaginary plane constructed drawn perpendicular to a longitudinal axis of the optical collimator.

6. The optical collimator as described in claim 5, wherein each angle is preferably between 6 and 8 degrees.

7. The optical collimator as described in claim 3, wherein a focal point of the molded lens is located at the point where the optical fiber is flush with the forward face of the ferrule.

8. The optical collimator as described in claim 1, further comprising a mounting tube for receiving the ferrule and the molded lens therein.

9. An optical collimator for collimating light beams coming from an optical fiber, and for focusing parallel light beams entering a front end of the collimator to a point coinciding with an exposed end of the optical fiber, comprising:
at least one optical fiber having an exposed end;
a ferrule defining a through hole for receiving the at least one optical fiber and having a forward face flush with an exposed end of the at least one optical fiber;
a molded lens having a uniform refractive index, and defining a rearward face adjacent the forward face of the ferrule,

10. The optical collimator as described in claim 9, wherein the forward face of the ferrule forms an oblique angle with an imaginary plane constructed perpendicular to a longitudinal axis of the ferrule.

11. The optical collimator as described in claim 10, wherein the oblique angle is preferably between 6 and 8 degrees.

12. The optical collimator as described in claim 9, wherein the rearward face of the molded lens forms an oblique angle relative to an imaginary plane constructed perpendicular to a longitudinal axis of the molded lens.

13. The optical collimator as described in claim 12, wherein the oblique angle is preferably between 6 and 8 degrees.

14. The optical collimator as described in claim 9, wherein the forward face of the molded lens defines a convex surface.

15. The optical collimator as described in claim 9, wherein the forward face of the ferrule is positioned at a focal point of the molded lens.

16. The optical collimator as described in claim 9, wherein the ferrule and the molded lens are fixed relative to one another.

17. The optical collimator as described in claim 9, further comprising a mounting tube having a receiving cavity for receiving and securing the ferrule and the molded lens therein.

18. The optical collimator as described in claim 9, wherein the molded lens is made entirely by injection molding.

19. The optical collimator as described in claim 9, wherein an antireflective coating is applied to the forward face and the rearward face of the molded lens.

20. An optical collimator comprising:
an optical fiber;
a ferrule enclosing said optical fiber;
a molded lens located adjacent to the ferrule; and
a mounting tube enclosing both the ferrule and the molded lens; wherein
said molded lens defines a convex positioned outside of the mounting tube and opposite to the ferrule.
